(19) United States
(12) Patent Application Publication
(10) Pub. No.: US 2015/0140944 A1
(43) Pub. Date: May 21, 2015

(54) METHOD OF NOTIFYING OF SITUATION THROUGH COMMUNICATION TERMINAL

(71) Applicant: SPACOSA Corp., Seongnam-si (KR)

(72) Inventor: Wonki KIM, Gwangju-si (KR)

(73) Assignee: SPACOSA Corp., Seongnam-si (KR)

(21) Appl. No.: 14/140,633

(22) Filed: Dec. 26, 2013

(30) Foreign Application Priority Data
Nov. 19, 2013 (KR) 10-2013-0140578

(51) Int. Cl. H04W 4/22

(52) U.S. Cl. CPC H04W 4/22
USPC 455/404.1

(57) ABSTRACT

Disclosed is a method of notifying of a situation through a communication terminal. The method includes providing a notification unit including an information receiver for transmitting and receiving notification information, in a communication terminal of each of members (step s1); requesting another communication terminal of another member to receive the notification information through a server unit by using one notification unit provided in one communication terminal, by one member (step s2); performing an authentication procedure for the one member who has requested the another communication terminal to receive the notification information, and requesting the another notification unit provided in the another communication terminal to transmit the notification information, by the server unit (step s3); receiving the request for transmitting of the notification information, and switching a state mode of the another communication terminal in order to transmit the notification information, by the another notification unit (step s4); and transmitting the notification information on situation information of the another member to the one communication terminal, by the another communication terminal of which the state mode has been switched (step s5).

### CROSS-REFERENCE TO RELATED APPLICATION

This application claims priority from and the benefit under 35 U.S.C. §119(a) of Korean Patent Application No. 10-2013-0140578, filed on Nov. 19, 2013, which is hereby incorporated by reference for all purposes as if fully set forth herein.

### BACKGROUND OF THE INVENTION

1. Field of the Invention

The present invention relates to a method of protecting members of a family by using a communication terminal (hereinafter, referred to as “terminal”) connected to a communications network, and more particularly, to a method of notifying of an emergency situation through a communication terminal, in which members connected to each other through a communications network share their location information with each other, so that one member can identify an emergency situation, which may occur to another member, through a terminal by using a single directional communication function.

2. Description of the Prior Art

In general, communication terminals correspond to a cellular phone, a Personal Communication Services (PCS) phone, a Personal Digital Assistant (PDA), a tablet Personal Computer (PC), and the like, and demands therefor have been rapidly increased. A personal telephone number of a subscriber is set in the communication terminal, and the subscriber may call other personal mobile communication terminals as well as a general phone anytime and anywhere or during moving to conveniently and promptly transfer information, so that utilization thereof has been rapidly extended.

The communication terminal connected to a wired or wireless communications network can perform two-way voice communication and two-way data communication through a call set-up between the communication terminals. In such a communication terminal, when an emergency situation such as fire, burglary, or abduction or kidnapping of an important person or child occurs, it is difficult to notify of such an emergency situation through a general call set-up procedure.

Meanwhile, when an emergency situation such as kidnapping or abduction occurs, a mobile communication service provider provides a service for enabling a member facing the emergency situation to transfer his/her location information or the fact that he/she faces the emergency situation to a specific member (a policeman and the like) by manipulating a specific button of a mobile communication terminal. However, since the member facing the emergency situation such as kidnapping or abduction cannot manipulate the specific button of the mobile communication terminal in most cases, such a service cannot substantially help the member.

Related arts proposed in order to solve such a problem described above include Korean Patent Laid-Open Publication No. 2013-0026682 entitled “a method of providing a personal safety confirmation service based on location by using a pattern alarm, and a system, a server, and a portable terminal therefor”.

### SUMMARY OF THE INVENTION

Aspects of a method of notifying of an emergency situation through a communication terminal according to the present invention are to solve the following problems.

First, an aspect of the present invention is to provide a method of enabling one member to identify a surrounding situation of another member without a voice call between the members according to a general call set-up, so as to promptly cope with an emergency situation which occurs to the another member.

Second, another aspect of the present invention is to provide a method of enabling one member to identify location information of another member, and when it is suspected that an emergency situation occurs, to actively identify a current state of the another member and to provide the current state of the another member to an emergency situation management agency (a police office, a fire station, or the like), so as to secure the safety of the another member.

Problems to be solved in the present invention are not limited to the above-mentioned contents, and other unmentioned problems to be solved may be clearly understood by those skilled in the art by the following descriptions.

A method of notifying of an emergency situation through a communication terminal according to the present invention has the following effects.

First, one member requests, through one notification unit provided in one communication terminal of the one member, a server unit to enable the one member to receive notification information from another communication terminal of another member, and a state mode of the another communication terminal is then changed by another notification unit provided in the another communication terminal of the another member to transmit notification information related to situation information to the one communication terminal, so that the one member can identify a surrounding situation of the another member without a voice call between the members according to a general call set-up, so as to promptly cope with an emergency situation which occurs to the another member.

Second, if situation information of the another member corresponds to emergency situation information when transmitting of notification information on the situation information of the another member to the one communication terminal is performed, the one notification unit requests the server unit to provide location information and notification information of the another member to an emergency situation management agency unit, so that, when the one member identifies location information of the another member and it is suspected that an emergency situation occurs, the one member may actively identify a current state of the another member and may provide the current state of the another member to an emergency situation management agency (a police office, a fire station, or the like), so as to secure the safety of the another member.

Effects of the present invention are not limited to the above-mentioned contents, and other unmentioned effects may be clearly understood by those skilled in the art by the following descriptions.

### BRIEF DESCRIPTION OF THE DRAWINGS

The above and other objects, features and advantages of the present invention will be more apparent from the following detailed description in conjunction with the accompanying drawings, in which:

FIGS. 1 and 2 are flowcharts describing a method of notifying of a situation through a communication terminal according to the present invention.

FIGS. 3 and 4 are concept views describing a method of notifying of a situation through a communication terminal according to the present invention.

### DETAILED DESCRIPTION OF THE EXEMPLARY EMBODIMENTS

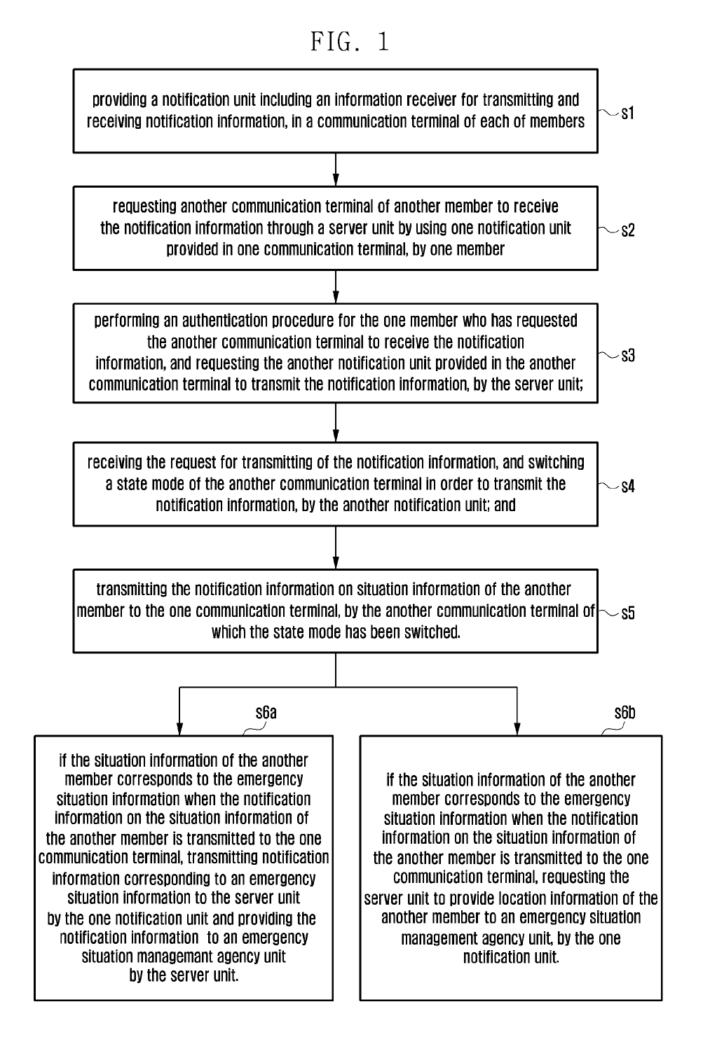

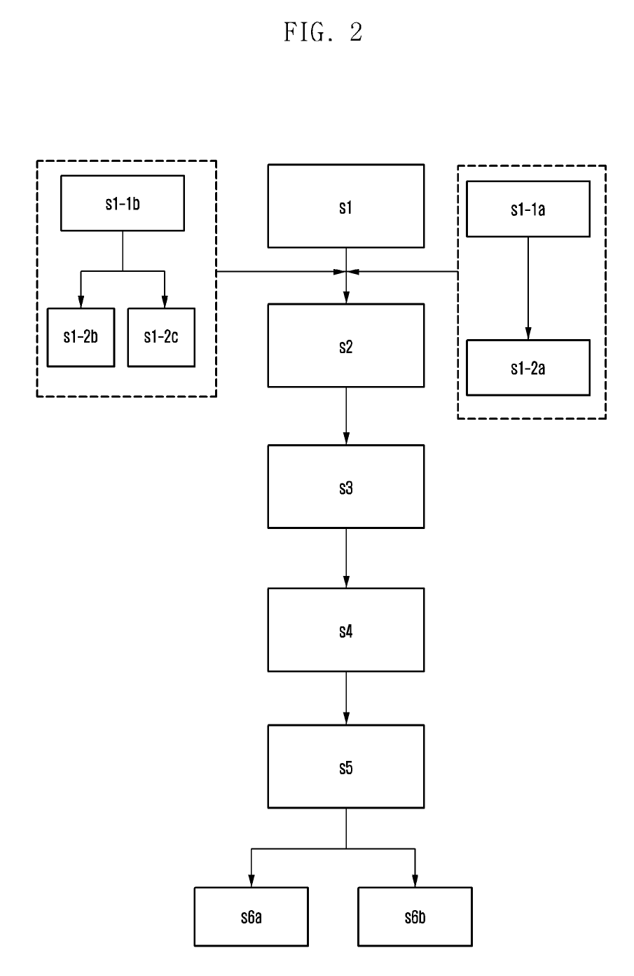

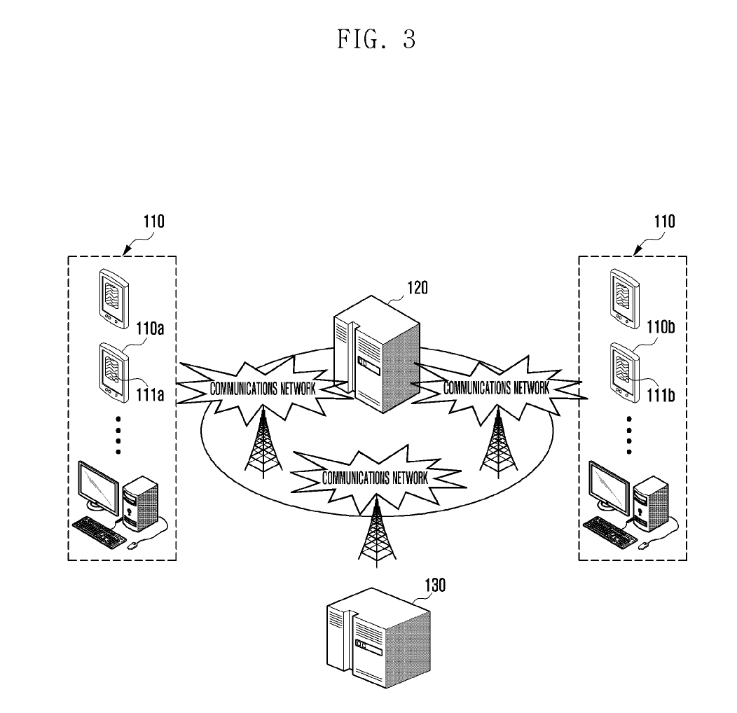

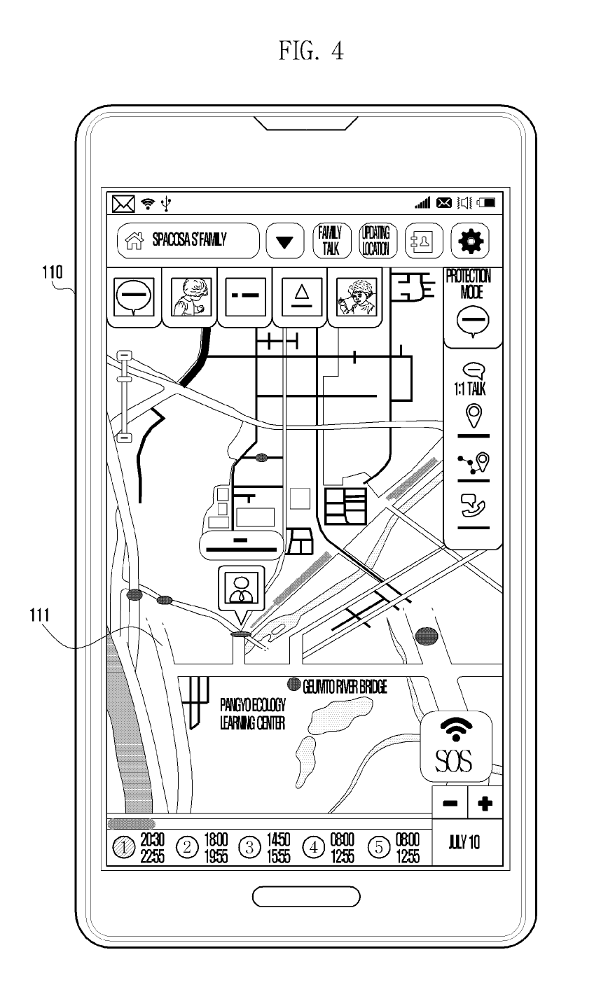

Hereinafter, a configuration and an operation of embodiments of the present invention will be described with reference to the accompanying drawings. FIGS. 1 and 2 are flowcharts describing a method of notifying of a situation through a communication terminal according to the present invention. FIGS. 3 and 4 are concept views describing a method of notifying of a situation through a communication terminal according to the present invention. As illustrated in FIGS. 1 and 2, a method of notifying of a situation through a communication terminal according to the present invention includes a step (step s1) in which a notification unit 111 including an information receiver for transmitting and receiving notification information is provided in a communication terminal 110 of each of members.

Further, the method includes a step (step s2) in which one member requests, through one notification unit provided in one communication terminal of the one member, a server unit to enable the one member to receive notification information from another communication terminal of another member.

Further, the method includes a step (step s3) in which the server unit 120 performs an authentication procedure for the one member who has requested the server unit 120 to enable the one member to receive the notification information from the another communication terminal 110b of the another member, and the server unit 120 requests the another notification unit 111b provided in the another communication terminal to transmit the notification information.

Further, the method includes a step (step s4) in which the another notification unit 111b is requested to transmit the notification information and switches a state mode of the another communication terminal 110b in order to transmit the notification information.

Further, the method includes a step (step s5) in which the another communication terminal 110b of which the state mode has been switched performs transmitting of the notification information on situation information of the another member to the one communication terminal 110a.

In the present invention, step s1 corresponds to a step in which the notification unit 111 is provided in the communication terminal 110 of each of members such as family members, friends, coworkers, and the like. The notification unit 111 corresponds to a form of an application program which is downloaded from the server unit 120 through a communications network and is installed and provided in the communication terminal of each of the members, as illustrated in FIG. 4. The notification unit 111 is connected to the server unit 120 through a wired or wireless communications network.

The wired communications network in the present invention may include an Internet communications network. Further, the wired communications network in the present invention implies various communications networks which can perform a voice call and data communication. Further, the wireless communications network implies various wireless communications networks such as a mobile communications network and a wireless Internet communications network. In addition, as illustrated in FIG. 3, the communication terminal corresponds to a communication terminal which is connected to various wired or wireless communications networks so as to perform a voice call and data communication.

The communication terminal corresponds to various terminals such as a smart phone, a cellular phone, a tablet PC, a notebook computer, and a personal computer. The communication terminal 110 may receive location information of the communication terminal from a Global Positioning System (GPS), and the communication terminals 110 of the members may share their location information with each other. The shared location information may be provided in each of the communication terminals 110 and may be confirmed through the notification unit 111 connected to the server unit 120.

The notification unit 111 may be installed in various terminals such as a tablet PC, a notebook computer, a personal computer, and the like. The present invention will be described focused on an example where the notification unit 111 is provided in a communication terminal such as a smart phone.

The notification unit 111 performs an authentication procedure for each of the members and permits a request for transmitting or receiving notification information to the members of which the authentication is completed. The notification unit 111 may include various driving menus. Further, the notification unit 111 may receive inputting of privacy information such as a social security number, a cell phone number, a home address of the member who uses the communication terminal, to perform the authentication procedure for the member. To this end, a comparison operation between privacy information stored in server unit 120 and the input privacy information is performed. The authentication procedure performed in the notification unit 111 may not be limited to one procedure, and may adopt various methods of authenticating the members using the communication terminals.

Step s2 corresponds to a step in which the one member among the plurality of members requests the server unit 120 to enable the one member to receive the notification information for identifying a situation of the another member. The request for receiving the notification information is made through the one notification unit 111a provided in the one communication terminal of the one member.

Step s2 corresponds to a step performed if a location of the another member deviates from an expected path when the one member among the plurality of members identifies location information of the another member through the notification unit 111 provided in the communication terminal 110 in a form of an application program. In step s2, the one member may identify a location of the another communication terminal 110b of the another member on a map through the one notification unit 111a.

In step s2, the one member passes through the authentication procedure through the one notification unit 111a. When it is authenticated through the authentication procedure that the members are connected to each other by the notification units 111, the request for receiving the notification information from the another member which has been made by the one member is transmitted to the another notification unit 111a of the another member through the server unit 120. At this time, the server unit 120 performs the authentication procedure for the one member who has made the request for receiving the notification information. The request for receiving the notification information from the another member is made to only members of which the authentication procedures have been completed through the server unit 120.

In the present invention, the notification unit 111 supports a relationship mode which can set relations between members. For example, when some members are in a family relation, one member selects a parent mode at one notification unit 111a, and another member selects a child mode at another notification unit 111b. The relationship mode is not limited to one mode, and may include various modes.

In the present invention, the notification information of which receiving and transmitting is performed when receiving and transmitting of the notification information is requested includes a protocol definition for transceiving (transmitting and receiving) of the notification information and a protocol definition for the authentication procedure.

In step s2, the one notification unit 111 of the one member is displayed by various icons depending on the location on a map on which the another communication terminal 110b moves, according to the location of the another communication terminal 110b of the another member. The icons may be changed, and is not limited to one type.

Step s3 corresponds to a step in which the authentication procedure for the one member who has requested receiving of the notification information is performed and the request for the one member to receive the notification information, the authentication procedure for the one member having been completed, is transferred to the another member. At this time, the another communication terminal 110b of the another member receives a request for transmitting notification information, from the server unit 120.

The another communication unit 111b of the another communication terminal 110b which has received the request for transmitting the notification information, from the server unit 120, passes through a process for transmitting situation information of the another member to the server unit 120 in step s4.

Step s4 corresponds to a step in which the another notification unit 111b provided in the another communication terminal 110b of the another member switches a state mode of the another communication terminal 110b in order to transmit the notification information to the one member. The information converted at the time of the state mode switching is transmitted to the server unit 120.

In Step s4, the another notification unit 111b switches the state mode of a speaker for the another communication terminal 110b into a silent mode. In step s4, since the speaker mode of the another communication terminal 110b of the another member is switched into a silent mode, surrounding people may not know that information on a situation in which thugs or robbers threaten the another member is being transmitted. Thus, the another member may transmit the situation information to the one member, so as to escape from the threat.

Further, in Step s4, the another notification unit 111b switches the state mode of a microphone for the another communication terminal 110b into an omnidirectional microphone mode. In addition, in Step s4, the another notification unit 111b switches the state mode of a screen for the another communication terminal 110b into a switched-off screen mode. In step s4, the microphone mode is switched in order to transmit the situation information to the one communication terminal 110a of the one member, and surrounding situations of the another member may be transmitted to the one communication terminal 110a of the one member in a form of a voice call.

In step s4, when the another communication terminal 110b is an Android phone, the state mode of the another communication terminal 110b may be controlled by using a Software Development Kit (SDK) for controlling a device and basically provided in an Android system. In particular, the control may be realized by importing an internal telephony library or may be realized by receiving a SDK for controlling a device from a manufacturer of each device. Here, the device manufacturer corresponds to a communication terminal manufacturer, a software manufacturer of the device, and the like. The present invention is not limited thereto, and may be realized and controlled also in an operating system of a commercialized communication terminal.

Thus, through step s4, when the another member is threatened, the one member may receive sounds generated around the another member through the one communication terminal 110a. In this process, since the speaker mode is set to a silent mode, surrounding people cannot know transmitting of the situation information. Transmitting of the notification information on the situation information is performed by transmitting voice-call information by the another communication terminal 110b.

Step s5 corresponds to a step in which the situation information of the another member according to the conversion of the state mode of the another communication terminal 110b, performed in step s4, is transmitted to the one communication terminal 110a of the one member. At this time, since the situation information has a form of voice-call information, the transmitting of the situation information is performed like a voice call.

In step s5, the another notification unit 111b of the another communication terminal 110b calls the one communication terminal 110a to perform transmitting of the notification information on the situation information of the another member. Further, in step s5, the another notification unit 111b transmits information thereof on the switched state mode of the another communication terminal 110b, to the server unit 120, and the server unit 120 requests the one notification unit 111a to record the situation information obtained from the received notification information.

To this end, the notification information on the situation information of the another member, which is received through the another communication terminal 110b, is recorded in the one communication terminal 110a. Since the recording function of the one communication terminal 110a is controlled by the one notification unit 111a, this operation is possible. For example, when the another member is frightened or threatened by thugs or robbers, sounds caused by the fright or the threat is recorded in the one communication terminal 110a by the one notification unit 111a. The notification information on the recorded situation information, having a voice information form, may be utilized as evidential material for an emergency situation which occurs to the another member.

Thus, the one member may identify location of the another member by each of the notification units 111 of the communication terminals 110, and the evidential material may be secured by the recorded notification information. Thus, it is possible to arrest the thugs or the robbers who frighten or threaten the another member, and it is possible to provide the evidential material for the emergency situation to the emergency situation management agency. Here, the emergency situation management agency implies a police office, a fire station, a constabulary, and the like.

A method of notifying of a situation through a communication terminal according to the present invention is utilized also at an emergency situation such as a fire. In addition, in a situation where it is difficult for the another member to notify the one member of his/her own emergency situation, the present invention may be utilized. The situation where it is difficult for the another member to notify the one member of his/her own emergency situation implies a situation where the another member cannot perform a call set-up with his/her another communication terminal 110b, that is, a situation where the another member cannot call the one member or the emergency situation management agency.

The method of notifying of a situation through a communication terminal according to the present invention further includes a step (step s6a) in which, if the situation information of the another member corresponds to emergency situation information when the notification information on the situation information of the another member is transmitted to the one communication terminal 110a, the one notification unit 111a transmits notification information corresponding to emergency situation information to the server unit 120, and the server unit 120 provides the notification information to an emergency situation management agency unit 130.

Further, the method of notifying of a situation through a communication terminal according to the present invention further includes a step (step s6b) in which, if the situation information of the another member corresponds to emergency situation information when the notification information on the situation information of the another member is transmitted to the one communication terminal 110a, the one notification unit 111a requests the server unit 120 to provide the location information of the another member to the emergency situation management agency unit 130.

Through step s6a and step s6b, when the another member is struck by an emergency situation, the one member can notify the emergency situation management agency that the another member is struck by the emergency situation. For example, in step s6a and step s6b, the emergency situation information, which corresponds to notification information received from the another member in the form of voice information, may include a sound of screaming, a sound of escaping from some places, a sound of someone being beaten, a sound of something burning, and the like. Further, the emergency situation information corresponds to the other sound information except for the typical sound information generated in a moving path of the another member. Here, step s6a and step s6b do not imply a specific sequence, and it is possible that step s6a is performed and step s6b is then performed, or step s6b is performed and step s6a is then performed.

Further, the method of notifying of a situation through a communication terminal according to the present invention further includes a step (step s1-1a) in which the one notification unit 111a sets a variation range for the location information of the another communication terminal 110b according to the moving path of the another member, and provides the variation range to the server unit 120.

Further, the method of notifying of a situation through a communication terminal according to the present invention further includes a step (step s1-2a) in which, when the another member deviates from a preset moving path so that location information of the another communication terminal 110b deviates from the variation range, the server unit 120 which has received the location information of the another communication terminal 110b transmits the location information to the one notification unit 111a, and the one notification unit 111a displays the location information and generates warning sounds.

In step s1-1a, the one member sets the moving path of the another member through the one notification unit 111a. In step s1-2a, when the another member deviates from the preset moving path, the another notification unit 111b of the another communication terminal 110b generates warning information for the location deviation of the another member and sends the warning information to the one notification unit 111a through the server unit 120. Through these operations, the one member may identify whether the another member deviates from the preset moving path in real time. In step s1-2a, the warning sound may be realized by various sounds and signs such as light.

The setting of the variation range for the location information of the another communication terminal 110b according to the moving path of the another member in the one notification unit 111a, which is performed in step s1-1a, may be displayed on a map displayed on the one notification unit 111a of the one member. The present invention is not limited thereto, and moving paths of public transportations corresponding to the moving path of the another member may be set.

In addition, the method of notifying of a situation through a communication terminal according to the present invention further includes a step (step s1-1b) in which time information is set through the one notification unit 111a, and a variation range for the location information of the another communication terminal 110b according to base location of the another member within the time information is set through the one notification unit 111a. Further, the method of notifying of a situation through a communication terminal according to the present invention further includes a step (step s1-2b) in which, when the base location information of the another communication terminal 110b of the another member within the preset time information deviates from the variation range, the server unit 120 which has received the location information of the another communication terminal 110b transmits the location information to the one notification unit 111a, and the one notification unit 111a displays the location information and generates the warning information.

The method of notifying of a situation through a communication terminal according to the present invention further includes a step (step s1-2c) in which, when the base location information of the another communication terminal 110b within the preset time information is not transmitted to the server unit 120, the server unit 120 displays the location information of the another communication terminal 110b before the transmitting is stopped and generates warning information.

Step s1-1b, step s1-2b, and step s1-2c are formed as one group, and in the one member and the another member, the one notification unit 111a of the one member set as a protection mode receives warning information when the location information of the another notification unit 111b of the another member deviates from the preset location.

For example, in step s1-1b, the one member sets the base location information of the another member at 4 P.M. as a school, and sets the variation range as an area from the school to a schoolyard. When the another member is not at school but at a game center at 4 P.M., the location information of the another communication terminal 110b of the another member is displayed as not school but an area around the game center on a map to the one notification unit 111a through step s1-2b. At this time, the server unit 120 generates warning information in various schemes and sends the warning information to the one notification unit 111a, so that the one member may identify a location of the another member and steps s2 to s5 are performed such that the another notification unit 111b can perform transmitting of the notification information.

Step s1-2c corresponds to a step in which the one member receives the warning information when the location information of the another communication terminal 110b of the another member within the preset time information which the one member sets through the one notification unit 111a is not displayed.

For example, in step s1-1b, the one member sets the base location information of the another member at 4 P.M. as a school through the one notification unit 111a and sets the variation range as an area from the school to a schoolyard. The location information of the another communication terminal 110b of the another member should be displayed as the school at 4 P.M. However, when the location information is not displayed, warning information is generated and is sent to the one notification unit 111a through step s1-2c. The one member who has received the warning information through the one notification unit 111a determines that an emergency situation occurs to the another member, and steps s2 to s5 are performed, so that the another notification unit 111b can perform transmitting of the notification information.

In the method of notifying of an emergency situation through a communication terminal according to the present invention, the one member uses the one notification unit 111a provided in the one communication terminal 110a to request the another communication terminal 110b of the another member to receive notification information through the server unit 120, and a state mode of the another communication terminal 110b is switched by the another notification unit 111b provided in the another communication terminal 110b of the another member to transmit the notification information on the situation information to the one communication terminal 110a, so that the one member can identify surrounding situations of the another member without a voice call between the members according to a general call set-up so as to cope with an emergency situation which occurs to the another member.

Further, if the situation information of the another member corresponds to an emergency situation information when the notification information on the situation information of the another member is transmitted to the one communication terminal 110a, the one notification unit requests the server unit to provide the location information and the notification information of the another member to the emergency situation management agency unit 130, so that, when the one member identifies the location information of the another member and then it is suspected that an emergency situation occurs to the another member, the one member can actively identify a current state of the another member and can provide the current state of the another member to an emergency situation management agency (a police office, a fire station, and the like), so as to secure safety of the another member.

Accompanying drawings of the present embodiments and the present specification clearly illustrate only a part of the technical spirits included in the present invention, and it is obvious that modified embodiments and detailed embodiments which can be analogized by those skilled in the art without departing from the technical spirits included in the specification and the drawings of the present invention are included in the scope of the present invention.

### DESCRIPTION OF REFERENCE NUMERALS

110: Communication terminal
110a: One communication terminal
111: Notification unit
111a: One notification unit
110b: Another communication terminal
111b: Another notification unit
120: Server unit
130: Emergency situation management agency unit

What is claimed is:

1. A method of notifying of a situation through a communication terminal, the method comprising:
providing a notification unit 111 including an information receiver for transmitting and receiving notification information, in a communication terminal 110 of each of members (step s1);
requesting a server unit 120 to enable one member to receive the notification information from another communication terminal 110b of another member through one notification unit 111a provided in one communication terminal 110a, by the one member (step s2);
performing an authentication procedure for the one member who has requested the server unit to enable the one member to receive the notification information, and requesting the another notification unit 111b provided in the another communication terminal to transmit the notification information, by the server unit 120 (step s3);
receiving the request for transmitting of the notification information, and switching a state mode of the another communication terminal 110b in order to transmit the notification information, by the another notification unit 111b (step s4); and
transmitting the notification information on situation information of the another member to the one communication terminal 110a, by the another communication terminal 110b of which the state mode has been switched (step s5).

2. The method of claim 1, wherein in the switching of the state mode of the another communication terminal 110b (step s4), the another notification unit 111b switches the state mode of a speaker for the another communication terminal 110b into a silent mode.

3. The method of claim 1, wherein in the switching of the state mode of the another communication terminal 110b (step s4), the another notification unit 111b switches the state mode of a microphone for the another communication terminal 110b into an omnidirectional microphone mode.

4. The method of claim 1, wherein in the switching of the state mode of the another communication terminal 110b (step s4), the another notification unit 111b switches the state mode of a screen for the another communication terminal 110b into a switched-off screen mode

5. The method of claim 1, wherein in the transmitting of the notification information on situation information of the another member to the one communication terminal 110a (step s5),
the another notification unit 111b of the another communication terminal 110b calls the one communication terminal 110a to perform transmitting of the notification information on the situation information of the another member.

6. The method of claim 1, wherein in the transmitting of the notification information on situation information of the another member to the one communication terminal 110a (step s5), the another notification unit 111b transmits information of the another communication terminal 110b on the switched state mode of the another communication terminal 110b, to the server unit 120, and the server unit 120 requests the one notification unit 111a to record the situation information obtained from the received notification information.

7. The method of claim 1, further comprising, if the situation information of the another member corresponds to the emergency situation information when the notification information on the situation information of the another member is transmitted to the one communication terminal 110a, transmitting notification information corresponding to an emergency situation information to the server unit 120 by the one notification unit 111a and providing the notification information to an emergency situation management agency unit 130 by the server unit 120 (step s6a).

8. The method of claim 1, further comprising, if the situation information of the another member corresponds to the emergency situation information when the notification information on the situation information of the another member is transmitted to the one communication terminal 110a, requesting the server unit 120 to provide location information of the another member to an emergency situation management agency unit 130, by the one notification unit 110a (step s6b).

9. The method of claim 1, wherein the notification unit 111 is an application program which is downloaded from the server unit 120 through a communications network and is installed and provided in the communication terminal.

10. The method of claim 1, wherein the notification unit 111 performs an authentication procedure for each of the members, and permits a request for transmitting or receiving notification information to the members of which the authentication is completed.

11. The method of claim 1, further comprising setting a variation range for location information of the another communication terminal 110b according to a moving path of the another member, and providing the variation range to the server unit 120, by the one notification unit 111a (step s1-1a).

12. The method of claim 11, further comprising, when the another member deviates from a preset moving path so that the location information of the another communication terminal 110b deviates from the variation range,
transmitting the location information to the one notification unit 111a by the server unit 120 which has received the location information of the another communication terminal 110b, and displaying the location information and generating warning sounds by the one notification unit (step s1-2a).

13. The method of claim 1, further comprising setting time information, and setting a variation range for location information of the another communication terminal 110b according to base location of the another member within the time information, through the one notification unit 111a (step s1-1b).

14. The method of claim 13, further comprising, when the base location information of the another communication terminal 110b of the another member within the preset time information deviates from the variation range, transmitting the location information to the one notification unit 111a by the server unit 120 which has received the location information of the another communication terminal 110b, and displaying the location information and generating warning information by the one notification unit 111a (step s1-2b).

15. The method of claim 13, further comprising, when the base location information of the another communication terminal 110b within the preset time set through the one notification unit 111a information is not transmitted to the server unit 120, displaying the location information of the another communication terminal 110b before the transmitting is stopped, on the one notification unit 111a, and generating warning information, by the server unit 120 (step s1-2c).
